(19) United States
(12) Patent Application Publication
(10) Pub. No.: US 2005/0181019 A1
(43) Pub. Date: Aug. 18, 2005

(54) Nutrition bar

(75) Inventors: Alan Edward Palmer, Naperville, IL (US); Brenda Jean Rudan, Ithaca, NY (US); Akhilesh Gautam, Arlington, TN (US); Michael Lynn Dagerath, Bartlett, TN (US); Matthew Patrick, Annapolis, MD (US)

Correspondence Address: UNILEVER INTELLECTUAL PROPERTY GROUP, 700 SYLVAN AVENUE,, BLDG C2 SOUTH, ENGLEWOOD CLIFFS, NJ, 07632-3100, US

(73) Assignee: Slim-Fast Foods Company, division of Conopco, Inc.

(21) Appl. No.: 11/001,547

(22) Filed: Dec. 1, 2004

Related U.S. Application Data
(63) Continuation-in-part of application No. 10/613,483, filed on Jul. 3, 2003.

(51) Int. Cl. A61K 47/00; A61K 35/78; A61K 33/24

(52) U.S. Cl. 424/439; 424/750; 424/757; 424/617

(57) ABSTRACT

A nutrition bar comprising about 10% wt or more of soy and/or rice protein, at least one transition metal or transition metal compound, and about 2% wt or more of a humectant, and wherein the at least one transition metal or transition metal compound is in a substantially water insoluble form at 20° C. or the nutrition bar has an Aw of 0.45 or less or about 1% wt or more of the soy and/or rice protein is in the form of nuggets and the humectant is selected from polyols. The bars have elevated levels of soy and/or rice protein, yet do not suffer unacceptable from a deterioration in taste or other organoleptic properties over time. In other aspects, a nutrition bar or other food which incorporates pro-oxidants and/or polyunsaturated fatty acids or their sources in encapsulated form, especially as microcapsules. The pro-oxidants may be metal salts such as copper, manganese, iron and/or zinc salts. Sources of omega-3 fatty acids include fish oil. Processes for preparing the polyunsaturated fatty acid capsules are also disclosed. The polyunsaturated fatty acid capsules/microcapsules are prepared by forming an emulsion of the unsaturated fatty acid with a carrier, spray drying the emulsion to form a powder and encapsulating powder, especially with a fluid bed. The invention is especially useful for encapsulating polyunsaturated fatty acids, or oil sources thereof, most preferably omega-3 and omega-6 fatty acids, such as arachidonic acid, docosahexaenoic acid (DHA), eicosapentaenoic acid (EPA), lineoleic acid, linolenic acid (alpha linolenic acid), and gamma-linolenic acids, fish oil, and oil sources of C18:2 and C18:3 fatty acids such as canola oil, soybean oil or blends thereof.

This is a continuation-in-part of Ser. No. 10/613,483 filed Jul. 3, 2003.

### BACKGROUND OF THE INVENTION

Increasingly, a focus of modern preventive medicine is weight reduction. Excessive weight is frequently cited in reports concerning the surge in cases of type 2 diabetes. Moreover, obesity is often mentioned in discussions of other modern diseases, such as heart disease.

For years a debate has raged as to which class of nutrients, fats or carbohydrates, are preferentially minimized to promote weight loss. Recently, much consumer attention has focussed on those who advocate reduction of carbohydrates and higher intakes of unsaturated fat and/or protein.

An increasingly popular form for ingestion of nutrients for those seeking to lose weight is the nutrition bar. The nutrition bar provides a convenient vehicle for replacing a meal or for supplementing meals as a snack. While consumers express a preference for snacks and other foods which are more healthful and which can assist them to achieve their weight loss goals, they show little inclination to sacrifice the organoleptic properties of their favorite foods. Therefore, the successful food formulator must improve the nutrient value of the food while maintaining desirable organoleptic properties.

High protein levels are particularly difficult to incorporate into good tasting foods since popular proteins, such as soy and/or rice, often have undesirable (after)tastes or develop such undesirable tastes or aftertastes upon storage. In particular, with certain products comprising soy and/or rice proteins an off-flavour may develop upon storage. Also the appearance and/or texture of such foods may deteriorate over time.

In addition to the increased emphasis on non-carbohydrate food components such as protein, much public attention has been paid in the last few years to a variety of other food ingredients which reportedly have beneficial properties for the health. Among the most celebrated of these are the omega-6 and especially the omega-3, fatty acids. One or more of these acids, and/or their sources, have been recommended for numerous conditions, such as high blood pressure, rheumatoid arthritis, undesirable cholesterol levels, mental acuity problems, infections, elevated blood lipids, and even cancer.

While it may be desirable to add omega-3 and/or omega-6 fatty acids and/or their sources to ingestable formulations, several characteristics of these nutrients make their inclusion in good tasting food products a challenge. For example, since these are polyunsaturated fatty acids, they have a tendency to oxidize.

Fatty acids other than fish oils also have been reported to have salutary properties, yet are susceptible to undesirable oxidation in the product. Most notable among these are the other polyunsaturated fatty acids (PUFA's).

Copper is a mineral, the health benefits of which are receiving increasing attention. Benefits concerning anemia, and decreased lipid oxidation in the body have been noted. Unfortunately, in many product formulations, copper tends to promote oxidation. And, special challenges are presented when omega-3, omega-6 or other polyunsaturated fatty acid (PUFA)-containing oils are present together with pro-oxidants such as copper since the presence of copper exacerbates the already substantial potential for oxidation inherent in the use of these.

Since consumers are reluctant to accept foods with poor organoleptic properties, notwithstanding any anticipated health benefits, it is highly desirable to prepare the foods in such a way that the likelihood of oxidation of any omega-3 and/or omega-6 fatty acids, any other polyunsaturated fatty acids and, indeed, any food components susceptible to oxidation in the presence of pro-oxidants like copper, is minimized.

There is considerable discussion of beneficial food components in the patent and other technical literature.

Gilles et al. U.S. Pat. No. 6,248,375 (Abbott Labs) discloses solid matrix materials designed for the person with diabetes. It includes a source of fructose in combination with at least one nonabsorbent carbohydrate. The two component carbohydrate system is said to blunt the postprandial carbohydrate response. One of the forms for administration mentioned is nutritional bars. Gilles et al. disclose in the examples nutritional bars comprising about 15 or 16% by weight of soy protein, about 4.6% by weight of glycerin and a vitamin and mineral pre-mix comprising zinc, iron and copper. Choice dm® Bar is cited as a nutritional bar for people with diabetes and including 17.1% total calories as protein in the form of calcium caseinate, soy protein isolate, whey protein concentrate, toasted soybeans, soy nuggets (soy protein isolate, rice flour, malt, salt) and peanut butter. Gluc-O-Bar® is said to be a medical food designed for use in management of diabetes which includes up to 23% of total calories as protein in the form of soy protein isolate, non fat dry milk, and peanut flour. The typical amount of protein in the Gilles bars is about 10% to about 25% of total calories, most preferably about 15 to about 20% of total calories. The bar may also include fish oil.

Keating et al. EP 768 043 (Bristol Meyers-Squibb) is directed to a nutritional composition for use by diabetics containing a controlled absorbed carbohydrate component. The carbohydrate component contains a rapidly absorbed fraction such as glucose or sucrose, a moderately absorbed fraction such as certain cooked starches or fructose and a slowly absorbed fraction such as raw corn starch. Preferred protein sources are said to include whey protein, sodium caseinate, or calcium caseinate, optionally supplemented with amino acids. Other preferred protein sources include protein hydrolysates such as soy protein hydrolysate, casein hydrolysate, whey protein hydrolysate, other animal and vegetable protein hydrolysates and mixtures thereof. Among the forms mentioned which the invention can take are a nutritional bar or cookie. The nutritional bars and cookies are preferably baked. The Keating et al. products may include fish oil.

WO 01/56402 discloses an alpha lipoic acid food supplement for increasing lean muscle mass and strength in athletes. A source of amino acids is included. Whey protein is said to be a preferred source of amino acids although other proteins which may be used include casein, other milk proteins, and albumins. The food supplements can be in a variety of forms such as protein bars. Portman U.S. Pat. No. 6,051,236 is directed to a nutritional composition in dry powder form for optimizing muscle performance during exercise. The compositions may be in the form of an energy bar. Soy protein is mentioned as one of the possible proteins. Alpha lipoic acid which may be encapsulated in liposomes.

Kaufman WO 01/33976 (Children's Research Hospital) is directed to a method for treating a type 2 diabetic to decrease hypoglycemic episodes and/or diminish fluctuations in blood glucose outside of the normal range, which comprises administering to the subject in an effective appetite suppressing amount a food composition, which can be a bar, which includes a slowly absorbed complex carbohydrate such as uncooked cornstarch. Soy protein, whey protein and casein hydrolysate are mentioned as possible protein sources.

DeMichele et al. U.S. Pat. No. 6,444,700 (Abbott Labs) is directed to immunonutritional products said to be useful in reducing the immunological suppression said to result from stress. Solid nutritional compositions such as bars are mentioned. Soy proteins are mentioned as possible ingredients for the solid compositions. Products which are useful for stress may include fish oils.

Lanter et al. U.S. Pat. No. 5,683,739 is directed to extruded animal feed nuggets comprising between about 90 and 99 wt % of at least one protein containing ingredient and between 1 and 6 wt % added fat. The nugget is prepared by plasticizing a blend of at least one protein-containing ingredient, added fat, sulfur (if present), and water, extruding the plasticized blend to form an animal feed nugget, and drying the extruded nugget to a water content of less than about 12 wt %. Protein sources mentioned include oil seed meals such as soybean meal and cottonseed meal, and animal byproduct meals such as meat meal, poultry meal, blood meal, feather meal, and fish meal, plant byproduct meal such as wheat middlings, soybean hulls, and corn byproducts and microbial protein such as torula yeast and brewer's yeast. U.S. Pat. Nos. 5,540,932 and 5,120,565 also are directed to animal feed nuggets which contain, or may contain, protein.

Other references disclosing food supplements which can be in the form of bars include WO 01/56402, Anon, “Nutraceuticals-International,” 2000, Vol 5, p25 (from abstract number 548502) Swartz, ML, “Milk proteins and hydrolysates in nutritional foods,” “Food Ingredients Europe: Conference Proceedings, London, October 1994, published in “Maarssen: Processs Press Europe,” 1994, 73-81 (from Abstract number 373368), and Swartz, ML, “Food-Marketing-&-Technology”, vol 9, 4, 6, 9-10, 12, 20 (from abstract number 1995-08-P0036)

Animal feed products which include fish oil have been proposed, for example, in U.S. Pat. Nos. 5,120,565 and 5,540,932. Various other foods have been described which mention nuggets which may include meat proteins. These include U.S. Pat. Nos. 6,086,941, 6,010,738.

Van Den Berg et al. U.S. Pat. No. 6,048,557 is directed to a process for preparing a polyunsaturated fatty acid (PUFA)-containing composition wherein a PUFA-containing lipid is adsorbed or coated onto a solid carrier, such as a powder. In Example 6, the PUFA is combined with a whey protein carrier using a fluidized bed granulator. Hijiya et al. U.S. Pat. Nos. 4,775,749 and 4,777,162 are directed to a cyclodextrin inclusion complex of eicosapentaenoic acid (EPA) and to a food product containing the compound. The undesirable odor of EPA is said to be masked by including it in the compound. The compound may be dried, pulverized and prepared into a granule or tablet.

EP 424 578 is directed to a dry solid composition containing lipids, such as fish oil, protected in sodium caseinate. The lipid contains from 10 to 50% by weight free fatty acid. The composition can be in free-flowing, particulate form. The composition is made by homogenizing acidic lipid and an aqueous caseinate solution together, and then drying as by fluid bed drying, spray drying or drum drying.

EP 425 213 is directed to a dry free flowing particulate composition containing from 70-95 wt % lipid, which is prepared by drying a liquid emulsion of lipid in an aqueous solution of sodium caseinate and dextrin having a dextrose equivalent of less than 10. It is said that the dry composition can protect unsaturated oils against oxidative deterioration. The liquid emulsion of lipid in an aqueous solution containing caseinate and dextrin can be dried by fluid bed drying, spray drying, or drum (film) drying. An especially preferred process is said to involve spray drying followed by agglomeration, e.g., using a fluidized bed. In an especially preferred embodiment, the lipid is fish oil.

EP 385 081 is directed to a dried fat emulsion. It describes prior processes in which the emulsions are prepared by emulsifying fat or oil which is then dried, such as by spray drying. The fat molecules are encapsulated by a film-forming material. In the '081 invention, a second portion of film forming material is added prior to or after drying, such as during “instantizing” of the dried emulsion concentrate. The second portion of film forming material is said to be effective in improving resistance of the dried fat emulsion products to oxidative deterioration and development of rancidity. The amount of film forming material in the aqueous dispersion should be sufficient to provide a continuous film encapsulating the fat globules in the emulsion. It is said that the dried emulsion product of the invention may be used in production of dry food systems.

Rubin U.S. Pat. No. 5,013,569 discloses an infant formula including DHA and EPA. It mentions various microencapsulation techniques for the DHA, EPA and for immunoglobulins.

GB Patent Application 2 240 702 is directed to a process for preparing a fatty fodder additive for domestic animals which increases the content of omega-3-fatty acids within the meats when the fodder additive is fed to the animal. The additives may be prepared by selecting a fat such as fish oil, selecting a carrier such as casein, homogenizing the oil and the carrier and drying using a spray drier or fluid bed. The powdered fat is then coated with an enteric coating material using a fluid bed coater. While claim 13 talks of a process for preparing “food” additives, in the context of the entire document, this may mean “fodder.”

Derwent abstract number 011973261 for FR 2 758 055 discloses a fluid powder comprising microcapsules consisting of fish oil rich in polyunsaturated fatty acids which are fixed onto a solid matrix which is a colloid associated with one or more carbohydrates. The fluid powder is obtained by emulsification and drying at low temperatures in a spray tower.

Schroeder et al. U.S. Pat. No. 4,913,921 is directed to food products wherein non-hydrogenated fish oil is stabilized by fructose. The invention is said to find particular suitability for use in connection with fish oils rich in omega-3 fatty acids. Various food products, such as dressings, are disclosed.

Skelback et al. U.S. Pat. No. 6,444,242 is directed to a microencapsulated oil or fat product wherein at least one oil or fat is dispersed in a matrix material, the oil or fat containing at least 10% by weight of highly unsaturated fatty acids, preferably omega-3 and omega-6 fatty acids. The microencapsulated oil or fat product is obtained by mixing the oil and an aqueous solution of caseinate, and optionally a carbohydrate-containing matrix, homogenizing, and drying the resulting emulsion to obtain free flowing microparticles. The emulsion may be spray dried, preferably in a modified spray dried process at a hot air temperature of 7° C. Fluid bed drying or drum drying may also be used. Infant formula, health functional food, and dietetic foods are among the. applications mentioned.

Skelback et al. mention two published Japanese patent applications, No. 85-49097 and 90-305898 disclosing powdered fish oils. One mentions encapsulation and the other spray drying.

WO 88/02221 is directed to a granulate comprising an oil-powder mixture which may contain marine oil having gamma linolenic acid (GLA), EPA and/or DHA. The oil/powder mixture is made by heating the oil, dissolving a defatted carrier in the oil, mixing, homogenizing, and drying using a conventional spray drier. The powder formed in the spray drier can be lowered to room temperature by passing a fluid bed dryer or similar device.

The Wright Group of Crowley, Louisiana offers the following wax-encapsulated minerals (metals or salts) under the name SuperCoat™:

WE101266 (Iron), WE 101265 (zinc). WE 101270 (copper) and WE 101267 (manganese).

The California Dairy Research Foundation website, www.cdrf.org/newsletter/dbfa1100/dbeat3.htm accessed on Apr. 17, 2004, indicated in its “Frequently Asked Questions About Edible Films and Coatings” portion of the Dairy Dispatch section that various edible waxes (e.g., beeswax, carnauba wax, candellia wax) are used to coat candies, pharmaceuticals and fresh fruits and vegetables. The waxes are said to provide a moisture and oxygen barrier and a glossy surface. Coatings on frozen foods to prevent oxidation and to prevent moisture, aroma or color migration are also mentioned. It is also said that research is underway at UC Davis involving combination of polysaccharides and proteins with various hydrophobic lipid materials (e.g., edible waxes, fatty acids, triglycerides including milkfat fractions) to achieve good moisture barrier coatings and films with acceptable mechanical integrity.

WO 03/079818 discloses an alertness bar which may include sources of omega 3 fatty acids. Essential minerals are mentioned as well.

Sears U.S. Pat. No. 6,140,304 (Eicotech Corp.) discloses a bar having a marine oil containing EPA and copper. It is not clear in what form copper is incorporated into the bar.

A ZONEPerfect® Nutrition Bar, Chocolate Mint flavor, available for sale in the United States at least as of Jul. 28, 2004, discloses that it contains 3 mg of “OMEGA 3” and lists fish oil among its ingredients. The package is marked “BEST BY 04/05”.

Despite the many previous efforts to formulate nutrition bars with high levels of protein there is still a need for a good tasting nutrition bar having elevated levels of protein, especially nutrition bars comprising soy and/or rice protein and desirable levels of certain minerals, especially transition metals. In particular, there is a need for such a nutrition bar which does not develop an off-taste on storage and which has good sensorial properties (in particular which is moist and chewy), even after prolonged storage at elevated temperatures e.g. 3° C. for 4 weeks. It is also desirable that the bar retains a pleasing appearance for the consumer upon storage e.g. does not brown or otherwise change colour. These have been found to be particular problems in nutrition bars comprising soy protein and transition metals and/or transition metal compounds.

And, although there have been many previous efforts to formulate foods with omega-3 and/or omega-6 and other unsaturated fatty acids, there is a need for a good way of incorporating copper and other pro-oxidant minerals (Mn, Fe, Zn etc.) into foods containing unsaturated fatty acids.

### SUMMARY OF THE INVENTION

The present invention is in one aspect directed especially to a nutrition bar which incorporates elevated levels of soy protein, at least one transition metal or transition metal compound, and about 2% wt or more of a humectant. In this aspect of the nutrition bar, the at least one transition metal or transition metal compound is in a substantially water insoluble form at 20° C., or, the nutrition bar has an Aw of 0.45 or less, or, about 1% wt or more of the soy and/or rice protein in the bar is in the form of nuggets and the humectant is selected from the group consisting of polyols.

Thus according to a first aspect the present invention provides a nutritional bar comprising;
a) about 10% wt or more of soy and/or rice protein, about 1% wt or more being in the form of nuggets,
b) at least one transition metal or transition metal compound, and
c) about 2% wt or more of a humectant selected from the group consisting of polyols.

According to a second aspect the present invention provides a nutritional bar comprising;
a) about 10% wt or more of soy and/or rice protein,
b) at least one transition metal or transition metal compound, and
c) about 2% wt or more of a humectant,
   and wherein the nutrition bar has an Aw of 0.45 or less.

According to a third aspect the present invention provides a nutritional bar comprising;
a) about 10% wt or more of soy and/or rice protein,
b) at least one transition metal or transition metal compound, wherein the at least one transition metal or transition metal compound is in a substantially water insoluble form at 20° C., and
c) about 2% wt or more of a humectant.

By the above-mentioned features of the invention, the nutrition bars are formulated to comprise elevated levels of protein yet do not suffer unacceptably from a deterioration in taste or other organoleptic properties (such as appearance e.g. browning or texture) over time. It is preferred that the bars of the invention do not suffer from the aforementioned problems for at least 6 months upon storage at 20° C., more preferably at least 7 months, most preferably at least 8 months, ideally at least one year.

Nuggets can have a variety of cross sections, e.g., circular, rectangular or square, and generally are bite sized particles having a maximum volume of 35 mm³ and a minimum volume of 4 mm³, preferably between 10 mm³ and 25 mm³. The soy and/or rice protein nuggets referred to herein will often comprise additional ingredients, such as a reducing sugar, in addition to the soy and/or rice protein.

In accordance with an additional aspect, the present invention is directed to nutrition products, such as nutrition bars and soups, sweet powders and other food products, especially those with a water activity (aw) of 0.75 or less, especially 0.65 or less, as well as to processes for preparing such products, wherein the products incorporate omega-3 and/or omega-6 and/or other polyunsaturated fatty acids in combination with pro-oxidant minerals such as copper compounds.

The formulations according to this additional aspect of the invention can be expected to have a very good shelf life, yet include polyunsaturated fatty acids which generally have a tendency to oxidize, together with normally pro-oxidant compounds in encapsulated form, especially copper. Previously it would have been expected that where pro-oxidant copper and omega-3 or other unsaturated fatty acids are combined in the same formulation, the fatty acids would oxidize and the shelf life of the food product would be unacceptable.

In accordance with a preferred aspect of the invention, the pro-oxidant is encapsulated with carnauba wax and/or other waxes.

In another aspect, the present invention is directed to a process for incorporating polyunsaturated fatty acids or a source thereof, especially omega-3 and/or omega-6 fatty acids, into copper- or other prooxidant-containing foods for human consumption, especially nutrition bars, soups and sweet powders, by utilizing encapsulated pro-oxidant. Preferably the polyunsaturated fatty acids are encapsulated with carnauba wax.

An especially preferred blend of oils for use as a source of polyunsturated fatty acids in the bars, pastas, powdered beverages, soups and other foods of the invention is a blend of canola and soybean oils at a weight ratio canola to soybean of from 35:65 to 65:35, especially about 50:50. The blend may be used in the bars and other foods of the invention at levels of from 2 to 25 wt %, especially from 5 to 20 wt %, most especially from 8 to 12 wt %. The blend provides a good, stable source of omega-3 and omega-6 fatty acids. For instance, levels of 0.15 to 0.2 g/serving of omega-3 and 1 to 2 g per serving of omega-6 are readily provided by the canola/soybean blend in food having an excellent shelf life as long as 12 or even 14 months. The canola/soybean blend preferably includes antioxidants, in particular BHT or TBHQ or a combination of ascorbic acid and rosemary extract, preferably at levels of 50 to 3000 ppm.

In accordance with another aspect of the invention, the omega-3 or omega-6 fatty acids are themselves encapsulated. Especially preferred is to use omega-3, omega-6 or other polyunsaturated fatty acids encapsulated by spray drying the fatty acid onto a carrier such as corn-, milk-, soy- and other proteins, or starch or other polysaccharides, and then encapsulating the spray dried fatty acid with wax or other encapsulating agent. Preferably the encapsulated polyunsaturated fatty acids are used in a nutrition bar or other food product, particularly one which includes the encapsulated pro-oxidants.

In the first step of the process, polyunsaturated fatty acids, and most especially omega-3 and/or omega 6 acids, are combined with a carrier and spray dried to form a powder. Typically an emulsion will be formed with the carrier and the unsaturated acids prior to spray drying. Examples of suitable carriers include modified food starches, maltodextrins, proteins such as soy protein and caseinate, sugars and mixtures thereof. Then, the spray dried powder is encapsulated, for example in a fluid bed dryer or a rotating disc, with one or more encapsulating agents. Among the contemplated encapsulating agents are hard fats (solid at 72° F.), edible waxes, especially higher melting point waxes, cellulose and protein, e.g., milk proteins such as caseinates, and zein.

The unsaturated fatty acids can be present as free fatty acids, but more typically will be present esterified to glycerol as mono-, di- or most preferably tri-acylglycerols. Unless otherwise required by context, references to any unsaturated fatty acids herein includes also reference to sources thereof such as triacylglycerols.

The encapsulated oils, may then be incorporated into a food for human consumption. Suitable examples include nutrition bars, ready-to-drink beverages, soups, and spreads, and other foods, preferably those with aw of 0.75 or less, preferably 0.65 or less, especially 0.6 or less, such as breakfast cereals, baked goods, etc. It is anticipated that the spray dried and encapsulated oils will be less susceptible to oxidation and the off tastes which accompany oxidation and which are also inherently present in the oils and sources thereof. Most preferably, the food includes both the encapsulated pro-oxidant(s) such as copper and the encapsulated polyunsaturated fatty acid(s).

The term “comprising” is meant not to be limiting to any subsequently stated elements but rather to encompass non-specified elements of major or minor functional importance. In other words the listed steps, elements or options need not be exhaustive. Whenever the words “including” or “having” are used, these terms are meant to be equivalent to “comprising” as defined above.

Except in the operating and comparative examples, or where otherwise explicitly indicated, all numbers in this description indicating amounts of material or conditions of reaction, physical properties of materials and/or use are to be understood as modified by the word “about.” All amounts are by weight, based on the total weight of the relevant product, unless otherwise specified.

Unless stated otherwise or required by context, the terms “fat” and “oil” are used interchangeably herein.

Unless stated otherwise or required by context, the terms “nutritional bar(s)” and “nutrition bar(s)” are used interchangeably herein.

For a more complete explanation of the above and other features and advantages of the invention, reference should be made to the following description of the preferred embodiments. The preferred embodiments apply to all aspects of the invention and can be used as appropriate for each aspect.

### DETAILED DESCRIPTION OF THE INVENTION

Protein

In accordance with one aspect of the invention, the nutritional bars of the invention comprise about 10% wt or more in total of soy and/or rice protein based on the total weight of the composition. It is preferred that the nutritional bars comprise 12% wt to 40% wt, e.g. 12% wt to 35% wt of soy and/or rice protein, more preferably 13% wt to 30% wt, most preferably 14% wt to 25% wt based on the total weight of the composition.

The soy protein may be present in any suitable form including as isolated soy protein, as soy protein concentrate or as soy protein hydrolysates. Sources of rice protein include rice flour and rice protein concentrate.

Without wishing to be bound by theory, it is believed that soy and/or rice protein based nutritional bars may suffer from problems of off-flavour development etc because of the presence of free amino acid groups.

According to the first aspect of the invention, the nutritional bars comprise 1% wt or more of the soy and/or rice protein, based on the total weight of the composition, in the form of nuggets (hereinafter protein nuggets). For the other aspects of the invention this is preferred. It is especially preferred that the nutritional bars comprise 5% wt or more soy and/or rice protein in the form of nuggets, more preferably 10% wt or more. It is especially preferred that the nutritional bars comprise 5% wt to 25% wt soy and/or rice protein in the form of nuggets, especially 10% wt to 20% wt. It is preferred that 80% wt or more of the soy and/or rice protein in the bar is present in the form of nuggets, more preferably 90% wt or more, most preferably 95% wt or more, such as 100% wt.

The protein nuggets preferably comprise 50% wt to 100% wt of soy and/or rice protein, more preferably 55% wt to 100% wt, most preferably 60% wt to 95% wt, such as 75% wt to 95% wt based on the weight of the protein nuggets.

In certain aspects of the invention, particularly where soy protein is not included or is minimized, when protein nuggets are employed, they typically include greater than 50 wt % of protein selected from the group consisting of milk protein, rice protein and pea protein and mixtures thereof, especially between 51 wt % and 99 wt %, more preferably between 52 wt % and 95 wt %, most preferably 55 wt % or above.

The protein nuggets of the invention may also comprise one or more of other proteins, such as those listed below, lipids, especially triglyceride fats, and carbohydrates, especially starches. It is especially preferred that the protein nuggets further comprise from 1% wt to 40% wt of a reducing sugar, more preferably 2% wt to 25% wt, most preferably 3% wt to 20% wt. Particularly where the nuggets are made using the moderated temperature extrusion process described below, it is advisable that the remaining ingredients be no more sensitive to heat degradation (e.g., have the same or lower degradation point) than the selected soy and/or rice protein or other nugget protein.

In addition to the soy and/or rice protein, other types of protein may also be included in the nutritional bars. Or, in other embodiments these proteins or protein may be used rather than soy and/or rice protein. Preferred sources for the other protein which may be used in the present invention (either within the protein nugget or within the bar external to the nugget) include dairy protein sources such as whole milk, skim milk, buttermilk, condensed milk, evaporated milk, milk solids non-fat, etc., and including whey protein such as whey protein isolate and whey protein concentrate and caseins; pea proteins and sources of pea protein; and sources of gelatin protein. The dairy source may contribute dairy fat and/or non-fat milk solids such as lactose and milk proteins, e.g. the whey proteins and caseins. The amounts of the other proteins, when present embodiments including soy and/or rice protein, are preferably within the range of from 1% wt to 10% wt, preferably 2% wt to 5% wt.

Especially preferred, to minimize the caloric impact, is the addition of protein as such rather than as one component of a food ingredient such as whole milk. Preferred in this respect are protein concentrates such as one or more of whey protein concentrate as mentioned above, milk protein concentrate, caseinates such as sodium and/or calcium caseinate, isolated soy protein and soy protein concentrate.

Total protein levels (soy and/or rice and other protein) within the nutrition bars of the invention, including any protein present in the form of nuggets, are preferably within the range of 3 wt % to 50 wt %, especially from 12% wt to 40% wt, more preferably 13% wt to 30% wt, most preferably 14% wt to 25% wt based on the total weight of the composition. Total protein levels within the foods of the invention, particularly when the food takes the form of a nutrition bar, may also in some instances be within the range of 3 wt % to 50 wt %, such as from 3 wt % to 30 wt %, especially from 3 wt % to 20%.

The total protein present in the nutritional bar preferably provides up to 50% of the total calories of the bar, more preferably between 20% and 50%, most preferably between 25% and 50%.

The present invention can be equally applied to milk protein based nutrition bars if the same problems are found in these bars.

Transition Metals and Transitional Metal Compounds

According to many aspects of the invention the nutrition bar comprises at least one transition metal or transition metal compound. The transition metal is preferably selected from chromium, manganese, iron, cobalt, nickel, copper and zinc and mixtures thereof. The transition metal compounds are preferably compounds of these transition metals. It has been found that iron, cobalt, nickel, copper and zinc can cause particular taste and sensorial problems in nutrition bars comprising soy and/or rice proteins.

According to the third aspect of the invention, the at least one transition metal or transition metal compound is in a substantially water insoluble form at 20° C. and this is preferred for the other aspects of the invention. The transition metal or transition metal compound may be provided in the substantially water insoluble form by any suitable means. It is preferred that either a substantially water insoluble salt is used or that a suitable encapsulant is used to achieve the desired level of water insolubility.

It is advisable to ensure that the transition metal or transition metal compound is in a substantially water insoluble form at all processing temperatures to which the nutrition bar is subjected during its preparation and ideally also at 5° C. or more above the maximum temperature reached.

Any substantially water insoluble compound of a transition metal may be used according to the invention, especially substantially water insoluble inorganic compounds. Such compounds selected from oxides, carbonates and phosphates including pyrophosphates are preferred. If copper is used then copper carbonate is preferred. If iron is used then ferric pyrophosphate is preferred. If zinc is used then zinc oxide is preferred.

The nutrition bars of the invention, typically overall comprise up to 100%, typically up to 50%, such as 10 to 35% of the European 2003 RDA of the transition metal. The exact amount of the transition metal and/or transition metal compound will depend upon the type used. Typically the nutrition bars will comprise one or more of up to 1 mg of manganese, up to 1.1 mg of copper, up to 9.5 mg of zinc and up to 16 mg of iron, preferably one or more of up to 0.5 mg of manganese, up to 0.4 mg of copper, up to 3 mg of zinc and up to 5 mg of iron

Alternatively, or additionally, the transition metal or transition metal compound may be encapsulated to render it substantially water insoluble. This provides a wider choice of the types of transition metal compound which may be used and may allow the inclusion of a more bioavailable compound to be used. Any suitable encapsulant may be used. It is especially preferred that an encapsulant is used which does not allow any significant water transmission across the encapsulation layer at temperatures below the melting point of the encapsulant. This is especially important where the encapsulated transition metal or transition metal compound is subjected to elevated temperatures, e.g. of 60° C. or more during the preparation of the nutrition bar.

The term “encapsulated” refers both to an embodiment wherein a coating is substantially formed around the transition metal or transition metal compound and to an embodiment wherein the transition metal or transition metal compound is trapped within or throughout a matrix so that it is rendered substantially water insoluble. The transition metal or transition metal compound preferably has a substantially integral encapsulant coating or matrix around it.

Suitable encapsulant materials include substantially water insoluble edible waxes, proteins, fibres, carbohydrates. The encapsulant material may be cross-linked.

Proteins which may be used as the entire encapsulant material, or as a part thereof, include gelatin, milk proteins (including caseinates, such as sodium caseinate, and whey proteins such as beta-lactoglobulin and alpha lactalbumin), albumin and vegetable proteins including proteins from beans, legumes and cereals such as soy, pea, maize and wheat and isolated soy proteins.

Carbohydrates which may be used as the entire encapsulant material, or as a part thereof, include mono or polysaccharides including, cellulose polymers and starches, (including hydrolysed and modified starches) and sugar alcohols. Suitable materials include gum arabic, carrageenan, agar agar, alginates, pectins and pectates.

Preferred encapsulants are carbohydrates such as alginates or pectins, especially including the sodium, potassium and calcium salts of alginates.

Mixtures of sodium caseinate and either gum arabic, carrageenan, agar agar, and gum arabic, are suitable. Similarly, beta-lactoglobulin and either gum arabic, carrageenan, agar agar, alginate or pectins, especially beta-lactoglobulin and gum arabic may be used.

It is preferred that the weight ratio of the transition metal and/or transition metal compound to the encapsulant is in the range of from 5:1 to 1:15, preferably 1:2 to 1:12, e.g. 1:5 to 1:10.

The transition metal or transition metal compound may be encapsulated by any suitable encapsulation technique as known in the art, such as coacervation or spraying on, and does not require further explanation here.

By the term “substantially water insoluble” is meant that the transition metal or transition metal compound does not substantially dissolve in water, in particular that it has a solubility in water at 20° C. of 1 g/100 g deionised water or less, preferably 0.5 g/100 g deionised water or less.

Encapsulated sources of copper or other pro-oxidants are preferably used herein when any oxidizable material may be present, such as PUFA's, and not only when soy or rice proteins are present. For some compositions, especially for compositions containing PUFA's such as omega 3 oils, encapsulated pro-oxidants are preferably present at a level of from 15 to 100% US RDA. Preferred, especially where PUFA's, e.g., omega 3 oils are present, are encapsulated copper salts such as microencapsulated cupric gluconate available from the Wright Group of Crowley, La. Another pro-oxidant copper salt which could benefit from encapsulation according to the present invention is copper sulfate. Encapsulated pro-oxidant salt products available from Wright include the following available under the name SuperCoat™:

We 101266 (Iron), We 101265 (zinc). We 101270 (copper) and We 101267 (manganese). Encapsulated pro-oxidant salts are preferably present at a level of from 0.3 to 0.85% by wt.

In accordance with one preferred aspect of the invention, the pro-oxidants are coated with an edible wax, such as beeswax, carnauba wax, candellia wax, paraffin wax or mixtures thereof. Preferably the wax has a melting point greater than 65° C. Alternatively, the pro-oxidant can be coated with another coating material which provides resistance to food processing conditions/variables such as temperature, shear, moisture and oxygen levels, such as stearic acid, hard fats, edible waxes, cellulose and protein. Examples of hard fats include hydrogenated soy bean or cotton seed oils. Preferably, the pro-oxidants are completely coated by the wax or other encapsulating agent.

Humectant

The nutrition bars according to all aspects of the invention preferably comprise 2% wt or more of a humectant. For the first aspect of the invention the bars comprise 2% or more of a humectant selected from the group (consisting of polyols). It is preferred that the nutrition bars comprise from 3% wt to 15% wt of humectants, more preferably 3% wt to 15% wt, especially 3% wt to 10% wt.

Any suitable humectant, and mixtures thereof, may be used for the second and third aspects. However, for all aspects it is preferred that the humectant is selected from polyols, with diols and triols being preferred, most especially triols. Suitable diols include sugar alcohol diols. Suitable triols include sugar alcohol triols, glycerol and sorbitol. At least for certain aspects of the invention, especially good results have been obtained when the humectant comprises glycerol, in particular when the nutrition bars comprise 3 to 10% weight glycerol, especially 4 to 7% wt glycerol.

Other humectants which may be used include fruit pastes such as raisin paste, prune pastes or date paste.

Aw

According to the second aspect of the invention, the nutrition bar has an Aw of 0.45 or less. This is also preferred for the other aspects of the invention. For all aspects of the invention, it is preferred that the nutrition bar has an Aw of 0.43 or less, most preferably of 0.40 or less. The determination of the Aw is within the normal skill of the skilled person and does not need to be described further here.

Fat/Carbohydrate

The source for any fat used in the nutrition bars, whether internal or external to the protein nugget, is preferably vegetable fat, such as for example, cocoa butter, illipe, shea, palm, palm kernal, sal, soybean, safflower, cottonseed, coconut, rapeseed, canola, corn and sunflower oils, or mixtures thereof. However, animal fats such as butter fat may also be used if consistent with the desired nutritional profile of the product. Preferably the amount of fat in either the protein nugget or the bar as a whole, is not more than 45 wt %, especially not more than 35 wt %, preferably from 0.5 to 20 wt %, more preferably from 1 to 15 wt %, most preferably from 1 to 5 or 10 wt %.

A blend of oils (e.g., canola, soybean, or high oleic oils) may be used, especially containing either synthetic antioxidants such as BHT, TBHQ or natural antioxidants such mixed tocopherols, ascorbic acid and rosemary extract or a blend of the above. When the source is for linoleic and linolenic acids (C18:2 and C18:3), straight oil or blends of oil such as canola plus soybean with an appropriate antioxidant system can be used. However, animal fats such as butter fat may also be used if consistent with the desired nutritional profile of the product.

Carbohydrates can be used within the protein nuggets at levels of from 1% to 35%. In addition to sweeteners mentioned below, and the fiber and carbohydrate bulking agents mentioned elsewhere, examples of suitable carbohydrates include starches such as are contained in rice flour, flour, tapioca flour, peanut flour, tapioca flour, tapioca starch, and whole wheat flour and mixtures thereof. These and other carbohydrates can be used outside the protein nuggets within the bar as well. Levels of carbohydrates in the bar as a whole will typically comprise from 5 wt % to 90 wt %, such as from 5 wt % to 80 wt %, especially from 20% to 65 wt %, such as from 25% to 60 wt %.

Optional Ingredients

If it is desired to include a bulking agent in the nutrition bars or other food, within or external to the protein nuggets, a preferred bulking agent is inert polydextrose. Other conventional bulking agents which may be used alone or in combination therewith include maltodextrin, sugar alcohols, corn syrup solids, sugars or starches. Total bulking agent levels in the protein nuggets, and in the nutritional bars and other foods of the invention, will preferably be from about 0% to 20 wt %, preferably 5% to 16%. Polydextrose may be obtained under the brand name Litesse.

Flavorings are preferably added to the nutrition bar in amounts that will impart a mild, pleasant flavor. The flavoring may be present in any protein nuggets or the capsules/microcapsules or external to the nuggets and the capsules/microcapsules in the bar or other food, provided that processing is not adversely affected. The flavoring may be any of the commercial flavors typically employed in nutrition bars, such as varying types of cocoa, pure vanilla or artificial flavor, such as vanillin, ethyl vanillin, chocolate, malt, mint, yogurt powder, extracts, spices, such as cinnamon, nutmeg and ginger, mixtures thereof, and the like. It will be appreciated that many flavor variations may be obtained by combinations of the basic flavors. The nutrition bars or other foods are flavored to taste and suitable amounts of each flavouring agent desired will therefore be included. Suitable flavorants may also include seasoning, such as salt (sodium choloride) or potassium chloride, and imitation fruit or chocolate flavors either singly or in any suitable combination. Flavorings which mask off-tastes from vitamins and/or minerals and other ingredients are preferably included in the products of the invention, in the protein nuggets and/or elsewhere in the product. Preferably, flavorants are present at from 0.25 to 3 wt % of the food, excluding salt or potassium chloride, which is generally present at from 0 to 1%, especially 0.1 to 0.5%.

The protein nuggets and/or nutrition bar and/or other food may include colorants, if desired, such as caramel colorant or vegetable or fruit colourings. Colorants are generally present in the food at from 0 to 2 wt %, especially from 0.1 to 1%.

If desired, the protein nuggets and/or nutrition bar may include processing aids such as calcium chloride.

The nutritional bars or other foods may comprise one or more cholesterol lowering agents in conventional amounts. Any suitable, known, cholesterol lowering agent may be used, for example isoflavones, phytosterols, soy bean extracts, fish oil extracts, tea leaf extracts.

The food product may optionally comprise, in suitable amounts, one or more agents which may beneficially influence (post-prandial) energy metabolism and substrate utilisation, for example caffeine, flavonoids (including tea catechins, capsaicinoids and canitine).

The protein nuggets and/or nutrition bar may also include emulsifiers. Typical emulsifying agents may be phospholipids and proteins or esters of long chain fatty acids and a polyhydric alcohol. Lecithin is an example. Fatty acid esters of glycerol, polyglycerol esters of fatty acids, sorbitan esters of fatty acids and polyoxyethylene and polyoxypropylene esters of fatty acids may be used but organoleptic properties, or course, must be considered. Mono- and di-glycerides are preferred. If present in the nuggets, emulsifiers may be used in amounts of about 0.03% to 0.3%, preferably 0.05% to 0.1%. The same emulsifiers may also be present in the nutrition bar, again at levels overall of about 0.03% to 1%, preferably 0.05% to 0.7%. Emulsifiers may be used in combination, as appropriate.

Among fiber sources which may be included in the nutrition bars or other food of the invention are fructose oligosaccharides such as inulin, soy fiber, fruit fibre e.g. apple, guar gum, gum arabic, gum acacia, oat fiber, cellulose, whole grains and mixtures thereof. The compositions preferably contain at least 2 grams of fiber per 56 g serving, especially at least 5 grams of fiber per serving. Preferably, fiber sources are present in the product at greater than 0.5 wt % and do not exceed 15 wt %, especially 10 wt %. In many embodiments, they will not exceed 5 or 6 wt %. As indicated above, additional bulking agents such as maltodextrin, sugar alcohols, corn syrup solids, sugars, starches and mixtures thereof may also be used. Total bulking agent levels in the products of the invention, including fibers and other bulking agents, will preferably be from about 0% to 20%, especially from 1 to 15 wt %. The fiber and the bulking agent may be present in the protein nuggets or in the bar or other food external to the nuggets provided that processing is not impaired.

Carrageenan may be included in the bars or other food of the invention, internal or external to any protein nuggets, eg, as a thickening and/or stabilizing agent. In many products levels of carrageenan will be from 0 to 2 wt % on product, especially from 0.2 to 1%). Cellulose gel and pectin are other thickeners which may be used alone or in combination. These may be used, for example, at 0 to 10 wt %, especially from 0.5 to 2 wt %.

Typically, if the food is a nutrition bar, or in any of a number product forms which are generally sweet, the food will be naturally sweetened. The sweetener may be included in the capsules/microcapsules or in any nuggets or elsewhere in the bar or food provided that it does not interfere with the processing of the capsule or nugget. Natural sources of sweetness include sucrose (liquid or solids), glucose, fructose, and corn syrup (liquid or solids), including high fructose corn syrup, corn syrup, maltitol corn syrup, high maltose corn syrup and mixtures thereof. Other sweeteners include lactose, maltose, glycerine, brown sugar and galactose and mixtures thereof. Polyol sweeteners other than sugars include the sugar alcohols such as maltitol, xylitol and erythritol. Levels of sweeteners and sugar sources preferably result in sugar and/or other polyol solids levels of up to 50 wt %, especially up to 20 wt %, preferably from 5 to 18 wt %, especially from 10 to 17 wt % of a nutrition bar or other food.

If it is desired to use artificial sweeteners, these may likewise be present in any microcapsule and/or any protein nuggets and/or within the bar or other food external to any nugget, provided that it does not interfere with processing, or elsewhere within the food. Any of the artificial sweeteners well known in the art may be used, such as aspartame, saccharine, Alitame® (obtainable from Pfizer), acesulfame K (obtainable from Hoechst), cyclamates, neotame, sucralose, mixtures thereof and the like. The artificial sweeteners may be used in varying amounts of about 0.005% to 1 wt % on the bar, preferably 0.007% to 0.73% depending on the sweetener, for example. Aspartame may be used at a level of 0.05% to 0.15%, preferably at a level of 0.07% to 0.11%. Acesulfame K is preferred at a level of 0.09% to 0.15%. Artificial sweeteners may be used in other foods at similar levels.

Calcium is preferably present in the nutrition bars or other foods at from 0 to 100% of US RDA, preferably from 10 to 30% US RDA, especially about 25% US RDA. The calcium source is preferably dicalcium phosphate. For example, wt. % levels of dicalcium phosphate may range from 0.5 to 1.5%. In a preferred embodiment, the product is fortified with one or more vitamins and/or minerals and/or fiber sources, in addition to the calcium source. These may include any or all of the following:

Ascorbic acid (Vitamin C), Tocopheryl Acetate (Vitamin E), Biotin (Vitamin H), Vitamin A Palmitate, Niacinamide (Vitamin B3), Potassium Iodide, d-Calcium Pantothenate (Vitamin B5), Cyanocobalamin (Vitamin B12), Riboflavin (Vitamin B2), Thiamine Mononitrate (Vitamin B1), Molybdenum, Chromium, Selenium, Calcium Carbonate, Calcium Lactate, Manganese (e.g., as Manganese Sulfate), Magnesium (e.g., as magnesium phosphate), Iron (e.g., as Ferric Orthophosphate) and Zinc (as Zinc Oxide). The vitamins and minerals are preferably present at from 5 to 100% US RDA, especially 5 to 50% US RDA, most especially from about 15% US RDA. The vitamins and/or minerals may be included within, or external to, the nuggets, provided that processing and human absorption are not impaired.

Minerals which tend to be pro-oxidants, such as iron, may be included in the encapsulated form according to the present invention.

US RDA as referred to herein is the Recommended Dietary Allowances 10^{th} ed., 1989, published by the National Academy of Science, National Academy Press, Washington, D.C.

An alternative measure used is RDI. One or more of these vitamins and minerals are preferably present at from 5 to 45% USRDI for 2003, especially 5 to 20% RDI, most especially from about 15% RDI.

It is especially preferred that the nutritional bars comprise at least 300 mg of potassium per serving, more preferably 400-1000, most preferably 450-700 mg.

The vitamins and/or minerals may be included within, or external to, any protein nuggets, provided that processing and human absorption are not impaired.

Ingredients which, if present, will generally be found within a bar but external to the capsules or any nuggets include, but are not limited to, rolled oats, chocolate or compound chips or other chocolate or compound pieces, cookie and/or cookie dough pieces, such as oatmeal cookie pieces, brownie pieces, fruit pieces, such as dried cranberry, apple, etc., fruit jelly, vegetable pieces such as rice, honey and acidulants such as malic and citric acids, leavening agents such as sodium bicarbonate and peanut butter.

The nutritional bars preferably have a calorie content in the range of from 50 kilocalories (kcals) to 250 kcals, more preferably 75 kcals to 200 kcals, most preferably 100 or 150 kcals to 400 kcals per bar.

A single serving size of the nutrition bar is typically in the range of from 45 g to 70 g, especially 50 g to 65 g, such as 55 g to 60 g.

Manufacture of Bars

The nutritional bars may be made by known methods provided that any protein nuggets are not exposed to temperatures which cause degradation of their ingredients, especially the proteins or encapsulant if present.

Extruded nutritional bars may be made by cooking a syrup containing liquid (at ambient temperature) ingredients and then mixing with dry ingredients. The mixture is then extruded onto a conveyor belt and cut with a cutter. Any nuggets, e.g., protein nuggets, are included among the dry ingredients. The capsules/microcapsules and any nuggets should only be added to the syrup when the syrup is at a temperature below that at which any of the capsules/microcapsule or nugget components degrade. Supercritical fluid extrusion of the bar as a whole at reduced temperatures can also be considered. Syrup ingredients may include components such as corn syrup, glycerine (e.g., 0-20 wt % on total product, especially 0.5 to 10 wt %), lecithin and soybean oil or other liquid oils. In addition to the capsules and any nuggets, other dry components which may be used include grains, flours (e.g., rice or peanut), maltodextrin and milk powders.

Nutritional bars in the form of granola bars may be made by cooking the syrup, adding the dry ingredients, blending the syrup and dry ingredients in a blender, feeding the blended mix through rollers and cutting with a cutter.

The bars of the invention may be fully or partially coated, eg with milk chocolate or yogurt flavored coating. Chocolates with little or no milk or milk products may be considered so as to maximize the presence of chocolate antioxidants and, if and to the extent desired, to try to avoid reported neutralization of antioxidants in the chocolate by milk or its components.

Typically, excluding moisture lost during processing, the uncoated bars of the invention will be made from 30-70 wt % syrup, particularly 30-50 wt % syrup, especially 35-65%, most especially 35-45%, and 30-70 wt % dry ingredients, especially 35-65 wt %, or 50-70 wt % dry ingredients, especially 55-65 wt %. Generally, coated bars according to the invention will be made from 30-50 wt % syrup, especially 35-45 wt %, 40-50 wt % dry ingredients, especially 40-45% and 0-30 wt % coating (e.g, chocolate or compound coating), especially 5-25 wt %, particularly 10-20 wt % coating.

The nutritional bar is preferably one intended to be used as part of a weight loss or weight control plan.

Alternative forms of the nutritional bars are powders, tablets and non-bar meal replacement products. The disclosures herein are equally applicable to these other product forms.

A meal replacement product as referred to herein refers to a product which is intended to replace one or more conventional meals per day; they are of a controlled calorie content and are generally eaten as a single product. Examples of meal replacement products include: liquid products such as milk or soya-based drinks, soluble powders used to prepare those drinks and drinks prepared therefrom, bars, soups, cereal or noodle or pasta-based products, desserts such as rice puddings, custards and the like. Meal replacement products are generally used by consumers following a calorie controlled diet. The nutritional bars of the invention may also be consumed as meal replacement products.

In accordance with one aspect of the invention, the present invention may be used to protect any polyunsaturated fatty acid in the food, and most especially to protect omega-3 and/or omega-6 fatty acids. Among the polyunsaturated fatty acids for which the invention may be useful are included arachidonic acid, docosahexaenoic acid (DHA), eicosapentaenoic acid (EPA), lineoleic acid, linolenic acid (alpha linolenic acid) and gamma-linolenic acid.

Among sources for the unsaturated acids which are encapsulated in accordance with the process of the invention, and/or which are protected by the encapsulated pro-oxidant according to the invention, may be included vegetable oils, marine oils such as fish oils and fish liver oils and algae. Possible vegetable oil sources include olive oil, soybean oil, canola oil, high oleic sunflower seed oil, high oleic safflower oil, safflower oil, sunflower seed oil, flaxseed (linseed) oil, corn oil, cottonseed oil, peanut oil, evening primrose oil, borage oil, and blackcurrant oil. As mentioned above, various other oils and fats may also be included in the product.

The food of the invention may be any of several foods which could be supplemented with and/or contain pro-oxidant minerals and polyunsaturated fatty acids. Preferably the food is a nutrition bar or is a food having a water activity of 0.75 or less, preferably 0.65 or less, especially 0.6 or less.

In general, where encapsulated oils containing PUFA moieties are used in accordance with the invention, added antioxidants such as tocopherols, ascorbic acid and/or rosemary extract may be omitted; that is, the oils may be free of added antioxidants. Where non-encapsulated oils containing PUFA moieties are used, it is preferred that added antioxidants such as tocopherols, ascorbic acid and/or rosemary extract be present in the oil.

Polyunsaturated fats, particularly those containing omega-3 and omega-6 fatty acids, are preferably incorporated as encapsulates in accordance with the process of the invention. Or, they can be incorporated into the product as oils, or in other forms such as alternative capsules or microcapsules, for example in the microcapsules of EP 648 076, the disclosure of which is incorporated by reference herein. The term “capsules” herein shall encompass encapsulates formed in accordance with the process of the invention and other encapsulating processes as well as shells into which a product has been placed. “Microcapsules” herein refers to capsules of very small size such as those of EP 648 076.

If desired, the food, especially the nuggets, may include processing aids such as calcium chloride.

As indicated above, in one of the aspects of the invention, the unsaturated oils will typically be emulsified with a carrier prior to spray drying. Typical emulsifying agents may be phospholipids and proteins or esters of long chain fatty acids and a polyhydric alcohol. Lecithin is an example. Fatty acid esters of glycerol, polyglycerol esters of fatty acids, sorbitan esters of fatty acids and polyoxyethylene and polyoxypropylene esters of fatty acids may be used but organoleptic properties, of course, must be considered. Mono- and di-glycerides are preferred. Emulsifiers may be used in the emulsions used to spray dry the unsaturated fatty acids in amounts of about 0.03% to 0.3%, preferably 0.05% to 0.1%. As mentioned above, the same emulsifiers may also be present in the nutrition bar or other food and/or protein nuggets, again at levels overall of about 0.03% to 0.3%, preferably 0.05% to 0.1%. Emulsifiers may be used in combination, as appropriate. Any nuggets may also include emulsifiers.

Typically the emulsion will be formed in a homogenizer such as a high pressure homogenizer from Invensys APV of Tonawanda, N.Y. The emulsion will typically comprise from 5 wt % to 25 wt % of carrier and 35 to 15 wt % of the unsaturated fatty acid. The emulsion typically will have about 40% solids and the balance water.

Encapsulated ingredients are added to the foods at a convenient time in the processing, provided that the capsules are not exposed to temperatures which cause degradation of their ingredients. Likewise, if protein-containing nuggets are present, the processor must be sensitive to any conditions which could cause degradation of the nugget.

Nuggets may contain greater than 50 wt %, especially greater than 60%, more preferably greater than 70 or 80% of selected non-soy proteins selected from the group consisting of milk protein, rice protein and pea protein.

This aspect of the invention, then, pertains to a process for making a food ingredient comprising, encapsulating unsaturated fatty acid or source thereof by forming an emulsion of the unsaturated fatty acid with a carrier, spray drying the emulsion to form a powder, and encapsulating said powder with an encapsulating agent. The powder may be encapsulated using a fluid bed or a rotating disc. The unsaturated fatty acid may be selected from the group consisting of arachidonic acid, docosahexaenoic acid (DHA), eicosapentaenoic acid (EPA), lineoleic acid, linolenic acid (alpha linolenic acid) and gamma-linolenic acid. The source of the unsaturated fatty acid which encapsulated may be a fish oil. The invention also pertains to the process of incorporating the food ingredient into a nutrition bar and to a nutrition bar into which the food ingredient has been incorporated, optionally together with an encapsulated prooxidant.

This aspect of the invention also relates to a process for making a food product for humans comprising, encapsulating unsaturated fatty acid or source thereof by forming an emulsion of the unsaturated fatty acid with a carrier, spray drying the emulsion to form a powder, and encapsulating the powder with an encapsulating agent, and incorporating the microencapsulated powder into a food for human consumption. The food for human consumption may be a nutrition bar. And, the microencapsulated powder may be incorporated into the nutrition bar by adding the microencapsulated powder to a syrup and extruding the syrup. In addition, the unsaturated fatty acid may be selected from the group consisting of arachidonic acid, docosahexaenoic acid (DHA), eicosapentaenoic acid (EPA), lineoleic acid, linolenic acid (alpha linolenic acid) and gamma-linolenic acid. The source which is encapsulated may be a fish oil. The invention also relates to a food product made according to the process.

Other Foods and Methods of Manufacture

It can be expected that the benefits of the invention will be realized in various types of foods, including various types of nutrition bars including, without limitation, snack bars and meal replacement bars. One example would be granola bars. Other applicable foods include soups and sweet powders which may be used to sweeten, flavor and fortify beverages such as milk.

Soups according to the invention are prepared by dry mixing the ingredients, as is known in the art. All seasoning is added to a ribbon blender (powder mixer). Mixing takes between 12 and 15 minutes depending upon the number of ingredients and size of the batch in the mixer. The mix is placed into a large tote that is taken to the packaging line.

In the case of powdered beverages, the product will typically be made using the following process. The ingredients are scaled to the quantity dictated in the formulation. The scaled ingredients are placed in a sifter placed over a 20 mesh standard screening unit. The ingredients are then bumped though the standard screen. The screened ingredients are emptied into a container, the lid is sealed and then the container is shaken vigorously for at least two minutes. The contents of the container are emptied into a 20 mesh standard screen and then stored in an air tight container. Beverages are typically prepared by scaling out the appropriate serving size of powder, scaling out 8 oz. of refrigerated skim milk, pouring milk into a blender vessel, turning the blender to a low setting and adding powder to the agitating skim milk, covering the blender vessel with an appropriate closure, increasing the speed to mid-high power, agitating at mid-high power for 20-30 seconds and then stopping agitation. The beverage is typically served and consumed shortly after preparation.

The invention will be further illustrated by reference to the following examples. Further examples within the scope of the invention will be apparent to the person skilled in the art.

### EXAMPLE 1

Two Granola-style nutrition bars were made to the following compositions:

| | A | B |
|---|---|---|
| | % wt | % wt |
| Binder: | | |
| Glucose syrup | 8.903 | 11.861 |
| Polydextrose syrup | 9.90 | 10.0 |
| Inulin syrup | 4.6 | 4.6 |
| Sugar | 2.3 | 2.3 |
| Pectose paste | 5.0 | 5.0 |
| Coconut oil | 2.3 | 2.3 |
| Lecithin | 0.6 | 0.6 |
| Glycerol | 5.0 | 1.242 |
| Invert syrup | 4.9 | 4.9 |
| Date paste | 3.0 | 3.0 |
| Corn oil | 2.1 | 2.1 |
| Flavourings | 0.375 | 0.375 |
| Colourings | 0.144 | 0.144 |
| Water loss | −3.20 | −3.20 |
| Dry material: | | |
| Oatflakes | 4.324 | 5.5 |
| Coconut flakes, | 2.2 | 2.2 |
| sweetened and | | |
| shredded | | |
| Fruit fibre | 4.15 | 4.15 |
| Soy protein nuggets | 6.0 | 6.0 |
| 1*¹ | | |
| Soy protein nuggets | 23.5 | 23.1 |
| 2*² | | |
| Vitamin/mineral mix*³ | 3.904 | 3.904 |
| Coating: | | |
| Dairy coating | 10.00 | 10.00 |
| A_{W} | 0.40 +/− 0.03 | 0.53 +/− 0.02 |
| Bar weight | 60.0 g | 60.0 g |
| *¹soy protein nuggets comprising 60% wt soy protein, available from Dupont Protein Technologies Inc., USA. | | |
| *²soy protein nuggets comprising 80% wt soy protein, available from Dupont Protein Technologies Inc., USA. | | |
| *³vitamin/mineral mix comprising zinc, iron, copper. In bar A there was 2 mg of zinc, 1 mg of iron and 0.18 mg of copper. In bar B there was 3 mg of zinc, 4.9 mg of iron and 0.34 mg of copper. For bar A, insoluble copper carbonate encapsulated with sodium alginate (1:9 weight ratio) was used. | | |
| # For bar B, soluble copper gluconate encapsulated with hardened soybean oil was used. | | |

Bar A was prepared by the following method of preparation; The glucose syrup, polydextrose syrup, inulin syrup, sugar, Pectose paste, coconut oil and lecithin, were heated together to about 250° F., 86.5 Brix and moisture loss recorded. The glycerol was added with mixing. Separately the invert syrup and date paste were mixed together and heated to 230° F. whereafter the mixture was added to the glycerol-containing mixture with stirring. The mixture was allowed to cool to 180° F. when the corn oil was added with mixing. After further cooling to 140° F., the flavours and colourings were added. The dry materials were mixed separately and added to the cooled mixture above with mixing until a uniform mixture was formed. Bars were formed by pressing the mixture into a mould, and when cooled to room temperature, cutting the cooled mixture into dimensions of 11 cm×3.5 cm×1.9 cm.

The bar was coated with the dairy coating which was allowed to 30 set.

Bar B was prepared by the method for bar A except the first heating stage was to 225-230° F., 83 Brix, that invert syrup was added with the other binder ingredients and the date paste was added with the colourings and flavouring. The bar was cut into dimension of 11 cm×3.5 cm×1.9 cm.

Results

The nutrition bars were stored under accelerated storage conditions at either 3° C. or 36° C., or, normal storage at 2° C. to assess them for off flavour development and a deterioration in the organoleptic properties. Bar A was stable after 4 months accelerated storage at 3° C. which is the equivalent of more than 12 months storage at 20° C., showing no unacceptable off-flavour development and no unacceptable deterioration in other organoleptic properties. The bars were still chewy, moist and with a good taste after 12 months storage at 2° C. No unacceptable browning of the bar was observed. Bar B was stable for only 4 weeks at 36° C. and 6 months at 20° C. but thereafter quickly produced a nutty off-flavour and browning.

### EXAMPLE 2

### Prophetic

Encapsulation Of A Polyunsaturated Fatty Acid

Into 1 kg of water are mixed 100 g milk protein, 50 g modified food starch, 50 g flow agent, and 200 g oil. The mixture is emulsified using a high pressure homogenizer. The emulsion is then spray dried under a nitrogen blanket in a Niro lab spray drier at a dryer temperature of 400° F. The control outlet temperature is 210° F. The powder thus made is introduced to a lab GLATT fluid bed. 100 g of the powder is fluidized and sprayed with carnauba wax coating at 30 g of carnauba wax and 10 g of paraffin at 212° F. under a nitrogen blanket. Other high coating compounds which can be used, alone or in combination, are beeswax and stearic acid.

### EXAMPLE 3

### Prophetic

The “center” of a coated bar is formed from the following components:

| Component | Wt % of Center |
|---|---|
| Protein | 25 |
| Sugar | 8 |
| Rice cereal | 16 |
| Soy protein | 6 |
| Vitamin/mineral | 4 |
| mix (including | |
| microencapsulated | |
| cupric gluconate | |
| ex Wright Group) | |
| Sodium chloride | 0.5 |
| Corn syrup | 28.5 |
| Molasses | 4 |
| Peanut butter | 4 |
| Encapsulated DHA/PUFA | 4 |
| (made by procedure | |
| of Example 2) | |

The liquid components are mixed, after which the dry ingredients are added and mixed until the product is substantially homogeneous. The encapsulated PUFA/DHA is added with the dry components. The mixture is then fed into a die and extruded at room temperature and atmospheric pressure. Upon extrusion, the bar is cut into individual serving sizes which are then coated with a chocolate confectioner's compound coating. The bar is packaged and kept at 85° F. for 12 weeks, after which it is opened and eaten. No off taste is detected. Each week of successful storage at 85° F. is believed to equate to one month of successful storage at ambient temperature.

### EXAMPLE 4

### Prophetic

Cream of Tomato Soup

| Ingredient Name | Product % |
|---|---|
| Whey Protein Concentrate | 25 |
| Tomato Power | 16-17 |
| Non fat dry milk | 14 |
| Instant Starch | 12 |
| Gum arabic | 8-9 |
| Sugar | 2-3 |
| Flavor Enhancer | 3-4 |
| Flavoring | 1-2 |
| Oil | 1-2 |
| Coloring | 1-2 |
| Agglomerated Calcium Caseinate | 1. |
| Disodium Phosphate | 1. |
| Onion Powder | 0.5 |
| Seasoning/spice | 1 |
| Garlic Powder | 0.2-0.3 |
| Gum, guar | 0.15-2 |
| Croutons | 4. |
| Vitamin/mineral | 4 |
| mix (including | |
| microencapsulated | |
| cupric gluconate | |
| ex Wright Group) | |
| | 100. |

It will be appreciated that when fatty acids are mentioned herein, generally these will present in the form of glycerides such as mono-, di- and triglycerides. Therefore, “fatty acids” encompasses glycerides containing them.

### EXAMPLE 5

### Prophetic

An alfredo sauce is made by mixing together the following ingredients:

| Ingredient Name | Ingredient % |
|---|---|
| Starch | 13.6 |
| Cream Cheese Tang | 9.6 |
| Milk Pro. Conc. | 12.7 |
| Gum Acacia | 8.5 |
| Vitamin Premix | 7 |
| Ca caseinate | 5.9 |
| Grated Parmesan, | 5.7 |
| Uncolored cheese | 4.5 |
| Salt | 4.4 |
| Solka Floc, FC 300 | 3.4 |
| Romano Cheese | 2.8 |
| Cream flavor | 2.8 |
| Drawn butter flavor | 2.1 |
| Butter Buds 8X | 1.4 |
| Dipotassium Phosphate | 1.4 |
| Sugar | 1.1 |
| Ti02, | 0.85 |
| MSG, | 0.7 |
| Lactic acid powder | 0.7 |
| Garlic powder | 0.6 |
| Xanthan gum | 0.28 |
| Black pepper | 0.2 |
| Ground Nutmeg | 0.1 |
| Parsley, Whole | 0.1 |
| Citric Acid, Anhydrous | 0.08 |
| OIL (Soybean + Canola, BHT) | 10 |
| | 100.51 |

The vitamin premix contains encapsulated copper. Despite the presence of appreciable amounts of triglycerides containing omega-3 and omega-6 fatty acids, the product enjoys an excellent shelf life.

### EXAMPLE 6

### Prophetic

A vanilla flavored beverage powder is made by mixing together the following ingredients:

| Ingredient Name | Ingredient % |
|---|---|
| Maltodextrin | 13.20% |
| Milk Protein Concentrate | 7.33% |
| Fiber | 7.33% |
| Carageenan | 0.83% |
| Premix, encapsulated Prooxidant | 4.70% |
| ACE-K | 0.15% |
| Aspartame | 0.15% |
| Avicel | 6.33% |
| Flavor | 2.50% |
| Xanthan Gum | 1.20% |
| Soybean + Canola oil | 10.50% |
| (50:50) + A.A + R.E | |
| Sugar | 39.00% |
| Soy Fiber | 5.10% |
| Lecithin | 0.52% |
| Salt | 0.60% |
| Guar gum | 0.50% |
| | 99.93% |

The product, which has encapsulated prooxidant minerals in the premix and which includes ascorbic acid and rosemary extract in the soybean/canola blend, is found to be organoleptically stable for 12 to 14 months.

Example 6 is repeated except that prooxidant minerals in the premix are not encapsulated and the soybean/canola oil blend lacks any added antioxidants. The shelf life of the product is reduced to 4-6 months.

It should be understood of course that the specific forms of the invention herein illustrated and described are intended to be representative only, as certain changes may be made therein without departing from the clear teaching of the disclosure. Accordingly, reference should be made to the appended claims in determining the full scope.

1. A nutritional bar comprising;
a) about 10% wt or more of soy and/or rice protein, about 1% wt or more being in the form of nuggets,
b) at least one transition metal or transition metal compound, and
c) about 2% wt or more of a humectant selected from the group consisting of polyols.

2. The nutritional bar according to claim 1 wherein the nutritional bar comprises about 12% wt to about 35% wt of soy and/or rice protein.

3. The nutritional bar according to claim 1 wherein the nutritional bar comprises about 5% wt or more soy and/or rice protein in the form of nuggets.

4. The nutritional bar according to claim 1 wherein the nuggets comprise about 55% wt to about 100% wt of soy and/or rice protein.

5. The nutritional bar according to claim 4 wherein the nuggets comprise about 75% wt to about 95% wt of soy and/or rice protein.

6. The nutritional bar according to claim 1 wherein the nuggets further comprise about 5% wt to about 25% wt of a reducing sugar.

7. The nutritional bar according to claim 6 wherein the polyol is selected from the group consisting of triols.

8. The nutritional bar according to claim 7 wherein the triol comprises glycerol.

9. The nutritional bar according to claim 1 comprising about 3% wt to about 20% wt of the humectant.

10. The nutritional bar according to claim 1 wherein the humectant comprises about 3% wt to about 10% wt of glycerol.

11. The nutritional bar according to claim 1 wherein the at least one transition metal or transition metal compound is selected from the group consisting of chromium, manganese, iron, cobalt, nickel, copper and zinc and their compounds and mixtures thereof.

12. The nutritional bar according to claim 1 wherein the at least one transition metal or transition metal compound is in a substantially water insoluble form at 20 ° C.

13. The nutritional bar according to claim 12 wherein the at least one transition metal or transition metal compound is substantially encapsulated in an encapsulation material.

14. A nutritional bar comprising;
a) about 10% wt or more of soy and/or rice protein,
b) at least one transition metal or transition metal compound, and
c) about 2% wt or more of a humectant, and wherein the nutrition bar has an Aw of 0.45 or less.

15. The nutritional bar according to claim 14 wherein the nutrition bar has an Aw of 0.43 or less.

16. A nutritional bar comprising;
a) about 10% wt or more of soy and/or rice protein,
b) at least one transition metal or transition metal compound, wherein the at least one transition metal or transition metal compound is in a substantially water insoluble form at 20° C., and
c) about 2% wt or more of a humectant.

17. The nutritional bar according to claim 16 wherein the at least one transition metal or transition metal compound is substantially encapsulated in an encapsulation material.

18. A nutrition bar comprising a polyunsaturated fatty acid and an encapsulated pro-oxidant.

19. The nutrition bar according to claim 18 wherein the encapsulated pro-oxidant is selected from the group consisting of salts of copper, iron, manganese and zinc.

20. The nutrition bar according to claim 18 wherein the pro-oxidant is encapsulated in a substance selected from the group consisting of stearic acid, hard fats, edible waxes, cellulose and protein.

21. The nutrition bar according to claim 20 wherein the wax is selected from the group consisting of beeswax, carnauba wax, candellia wax, and paraffin wax.

22. The nutrition bar according to claim 18 further comprising

| | |
|---|---|
| High Fructose Corn | 0%-45% |
| Syrup | |
| Corn Syrup | 0-35% |
| Maltitol Syrup | 0-60% |
| Glycerine | 0-20% |
| Proteins | 0-50% |
| Protein Nuggets | 0-75% |
| Whole Grains | 0-20% |
| Fiber | 0-10% |
| Fats & Oil | 0-10% |
| Vitamins and Minerals | 0-2% |
| Flavors Natural and | 0.25-3.0% |
| Artificial | |
| Maltodextrin | 0-10% |
| Water | 0-5% |
| Peanuts | 0-20% |
| Peanut Flour | 0-20% |
| | and |
| Tree Nuts | 0-10%. |

23. The nutrition bar according to claim 22 wherein the fiber comprises

| | |
|---|---|
| Oat Fiber | 0-5% |
| FOS | 0-5%, |
| Based on the weight of | |
| the nutrition bar. | |

24. The nutrition bar according to claim 23 further comprising:

| | |
|---|---|
| Caramel | 0-40% |
| Cocoa | 0-10% |
| Chocolate Liqueur | 0-3% |
| Chocolate or Compound | 0-30% |
| Coating | |
| Rice Flour | 0-5% |
| Guar Gum | 0-2% |
| Carrageenan | 0-2% |
| Non-nutritive | 0-1% |
| Sweeteners | |
| Honey | 0-10% |
| Fruit Jelly | 0-40% |
| Fruit Pieces | 0-20% |
| | and |
| Salt | 0-1%. |

25. The nutrition bar according to claim 18 comprising less than about 10 wt % of proteins selected from the group consisting of soy protein, rice protein and mixtures thereof.

26. The nutrition bar according to claim 18 comprising less than 8wt % of proteins selected from the group consisting of soy protein, rice protein and mixtures thereof.

27. The nutrition bar according to claim 18 comprising less than 1 wt % proteins selected from the group consisting of soy protein, rice protein and mixtures thereof in nuggets.

28. A process for making a nutrition bar comprising mixing, with one or more optional ingredients, one or more encapsulated pro-oxidants and one or more polyunsaturated fatty acids.

29. The process according to claim 28 wherein said polyunsaturated fatty acids are also encapsulated.

30. A food product, other than a nutrition bar, comprising a polyunsaturated fatty acid and an encapsulated pro-oxidant, said food product having a water activity of 0.75 or less.

31. The food product according to claim 30 having a water activity of 0.650 or less.

32. The food product according to claim 30 selected from the group consisting of soups and sweet powders.

33. The nutrition bar according to claim 18 wherein at least a portion of the polyunsaturated fatty acids are in the form of a fish oil.

34. The nutrition bar according to claim 18 wherein at least 3 wt % of the polyunsaturated fatty acids are selected from the group consisting of DHA and EPA.

35. The nutrition bar according to claim 18 wherein at least 5 wt % of the polyunsaturated fatty acids are selected from the group consisting of DHA and EPA.

36. The nutrition bar according to claim 18 which is not a granola bar.

37. The nutrition bar according to claim 18 wherein the pro-oxidant is encapsulated with a wax having a melting point greater than 65° C.

38. The food product according to claim 30 wherein the pro-oxidant is encapsulated with a wax having a melting point greater than 65° C.

39. The food product according to claim 38 wherein the pro-oxidant is encapsulated with carnauba wax.

40. The food product according to claim 30 wherein the wax is selected from the group consisting of beeswax, carnauba wax, candellia wax, and paraffin wax.

41. The nutrition bar according to claim 18 wherein said polyunsaturated fatty acid or source thereof is encapsulating prior to inclusion in said bar by forming an emulsion of the unsaturated fatty acid with a carrier, spray drying the emulsion to form a powder, and encapsulating said powder with an encapsulating agent.

42. The nutrition bar according to claim 18 wherein the unsaturated fatty acid source comprises a blend of canola oil and soybean oil.

43. The nutrition bar according to claim 42 wherein the blend is at a weight ratio of canola oil to soybean oil of from 65:35 to 35:65.

44. The nutrition bar according to claim 43 wherein the blend is used at a canola oil to soybean oil ratio of about 50:50.

45. The nutrition bar according to claim 42 wherein the blend of canola oil and soybean oil constitutes at least 98 wt % of the unsaturated fatty acid sources in the nutrition bar.

46. The nutrition bar according to claim 42 wherein the blend further comprises an antioxidant which is one or more of BHT, TBHQ or a combination of ascorbic acid plus rosemary extract.

47. The food product according to claim 30 wherein the unsaturated fatty acid source comprises a blend of canola oil and soybean oil.

48. The food product according to claim 47 wherein the blend is at a weight ratio of canola oil to soybean oil of from 65:35 to 35:65.

49. The food product according to claim 47 wherein the blend is used at a canola oil to soybean oil ratio of about 50:50.

50. The food product according to claim 47 wherein the blend of canola oil and soybean oil constitutes at least 98 wt % of the unsaturated fatty acid sources in the nutrition bar.

51. The food product according to claim 47 wherein the blend further comprises an antioxidant which is one or more of BHT, TBHQ or a combination of ascorbic acid plus rosemary extract.
